(19) United States
(12) Patent Application Publication
(10) Pub. No.: US 2011/0141854 A1
(43) Pub. Date: Jun. 16, 2011

(54) ACOUSTIC SENSOR AND METHOD OF FABRICATING THE SAME

(75) Inventors: Jae Woo LEE, Daejeon (KR); Kang Ho PARK, Daejeon (KR); Jong Dae KIM, Daejeon (KR)

(73) Assignee: Electronics and Telecommunications Research Institute, Daejeon (KR)

(21) Appl. No.: 12/708,765

(22) Filed: Feb. 19, 2010

(30) Foreign Application Priority Data
Dec. 14, 2009 (KR) 10-2009-0123740

(51) Int. Cl. H04R 17/00; C23F 1/00

(52) U.S. Cl. 367/180; 216/13

(57) ABSTRACT

A condenser-type acoustic sensor is provided. The acoustic sensor includes an acoustic chamber formed by etching an upper portion of a substrate, an insulating layer formed on the substrate and having a central area etched so that the acoustic chamber is exposed, a diaphragm formed on the insulating layer, and a stationary electrode formed on the diaphragm. Thus, a nonlinear component resulting from horizontal movement of the support and the diaphragm is removed to improve a sound-pressure response characteristic, and a substrate backside process can be omitted to simplify a fabrication process and improve a yield.

### CROSS-REFERENCE TO RELATED APPLICATION

This application claims priority to and the benefit of Korean Patent Application No. 10-2009-0123740, filed Dec. 14, 2009, the disclosure of which is incorporated herein by reference in its entirety.

### BACKGROUND

1. Field of the Invention

The present invention relates to a micro device using micro-electro-mechanical systems (MEMS) technology, and more particularly, to a condenser-type acoustic sensor.

2. Discussion of Related Art

Acoustic sensors include piezo-type acoustic sensors and condenser-type acoustic sensors.

A piezo-type acoustic sensor uses a piezoelectric effect that a potential difference is produced across a piezoelectric material when physical pressure is applied to the piezoelectric material. The piezo-type acoustic sensor converts pressure of a sound signal into an electrical signal. The piezo-type acoustic sensor has limited applications due to a nonuniform characteristic at low-band and sound-band frequencies.

Meanwhile, a condenser-type acoustic sensor is an application of a principle of a capacitor in which two electrodes face each other. One of the electrodes is stationary and the other electrode serves as a diaphragm. When the diaphragm vibrates with pressure of a sound signal, capacitance between the electrodes is changed and accumulated charge is changed, such that current flows. The condenser-type acoustic sensor has advantages of high stability and an excellent frequency characteristic. The condenser-type acoustic sensor is widely used due to the excellent frequency characteristic. A conventional condenser-type acoustic sensor will now be described with reference to FIG. 1.

FIG. 1 is a cross-sectional view of a conventional condenser-type acoustic sensor.

Referring to FIG. 1, a conventional acoustic sensor includes a lower electrode 102, a diaphragm 105 and a support 108 that are formed on a substrate 101.

The diaphragm 105 vibrates with sound pressure, and the support 108 supports the diaphragm 105. Each of the diaphragm 105 and the support 108 includes an insulating layer 106 and an upper electrode 107.

In the conventional acoustic sensor as shown in FIG. 1, the support 108 is formed in an “L” shape. This allows the support 108 to move horizontally when the diaphragm 105 vertically moves with sound pressure. Accordingly, when the diaphragm 105 vertically moves with sound pressure, a nonlinear component resulting from the horizontal movement of the support 108 is added to a linear change of the capacitance of a capacitor, thereby degrading a sound-pressure response characteristic of the acoustic sensor.

Meanwhile, when the condenser-type acoustic sensor is fabricated, the stationary lower electrode 102 and the diaphragm 105 are formed on the substrate 101 and then a rear acoustic chamber 109 is formed in a lower portion of the substrate 101. The rear acoustic chamber 109 is formed through a bulk-type micromachining semiconductor process in which an upper portion of the substrate 101 is protected by an insulating material and the lower portion of the substrate 101 is machined by about tens to hundreds of micrometers.

After the rear acoustic chamber 109 is formed in the lower portion of the substrate 101 through the bulk-type micromachining semiconductor process, a sacrificial layer is removed through lower-electrode holes 103. Accordingly, the condenser-type acoustic sensor with an upper electrode gap 110 is completed.

In the conventional condenser-type acoustic sensor as described above, a nonlinear component results from horizontal movement of the support and the diaphragm, which degrades a sound-pressure response characteristic of the acoustic sensor. Also, since the lower portion of the substrate must be necessarily machined to remove the sacrificial layer, the fabrication process is complex. Accordingly, a process yield is lowered and productivity is degraded.

Accordingly, there is a need for an acoustic sensor that has an improved sound-pressure response characteristic by removing the nonlinear component resulting from horizontal movement of the support and the diaphragm and that can be fabricated through a simplified process.

### SUMMARY OF THE INVENTION

The present invention is directed to an acoustic sensor having an improved sound-pressure response characteristic by removing a nonlinear component resulting from horizontal movement of a diaphragm and a support.

The present invention is also directed to a method of fabricating an acoustic sensor that is capable of simplifying a fabrication process and improving a yield by forming an acoustic chamber without etching a backside of a substrate.

Other objects of the present invention will be recognized by the following description and exemplary embodiments of the present invention.

One aspect of the present invention provides an acoustic sensor including: an acoustic chamber formed by etching an upper portion of a substrate; an insulating layer formed on the substrate and having a central area etched so that the acoustic chamber is exposed; a diaphragm formed on the insulating layer; and a stationary electrode formed on the diaphragm.

The acoustic sensor may further include a diaphragm gap formed between the insulating layer and the diaphragm. In this case, the acoustic sensor may include a self-sustaining support for supporting the diaphragm on the insulating layer. The self-sustaining support may be formed inward from an edge of the diaphragm. The self-sustaining support may be formed integrally with the diaphragm.

The acoustic sensor may further include etching holes formed with a pattern on the stationary electrode. The stationary electrode may be formed to surround the diaphragm on the insulating layer. The acoustic sensor may further include a stationary electrode gap formed between the diaphragm and the stationary electrode, and may further include etching windows formed between an outer circumference of the stationary electrode and the substrate.

The diaphragm may have a structure in which an insulating layer and a conductive layer are stacked.

Meanwhile, another aspect of the present invention provides a method of fabricating an acoustic sensor, including: forming an insulating layer on a substrate; etching a central area of the insulating layer to form an acoustic-chamber open pattern; forming a diaphragm on the insulating layer; forming a stationary electrode on the diaphragm; and etching an upper portion of the substrate, and forming an acoustic chamber exposed by the acoustic-chamber open pattern.

The formation of the diaphragm may include forming the diaphragm to be spaced from the insulating layer. In this case, the formation of the diaphragm may include: forming a first sacrificial layer to cover the acoustic-chamber open pattern and the insulating layer; forming the diaphragm on the first sacrificial layer; and etching and removing the first sacrificial layer.

The method may further include forming a self-sustaining support on the insulating layer to support the diaphragm. In this case, the formation of the self-sustaining support may include forming the diaphragm and the self-sustaining support through the same etching process.

The formation of the stationary electrode may include forming the stationary electrode to be spaced from the diaphragm. In this case, the formation of the stationary electrode may include: forming a second sacrificial layer on the substrate to cover the diaphragm; forming the stationary electrode on the second sacrificial layer; and etching and removing the second sacrificial layer.

The formation of the stationary electrode may further include forming etching holes having a pattern on the stationary electrode.

The formation of the stationary electrode may include forming the stationary electrode to surround the diaphragm on the insulating layer. The formation of the stationary electrode may include forming etching windows having a pattern between the insulating layer and an outer circumference of the stationary electrode.

Meanwhile, other advantages will be directly or implicatively disclosed in a detailed description of exemplary embodiments of the present invention that will be given below.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a cross-sectional view of a conventional condenser-type acoustic sensor;

FIGS. 2a to 2c illustrate an acoustic sensor according to an exemplary embodiment of the present invention;

FIG. 3a is a view taken along a section A1-A2 in FIG. 2a;

FIG. 3b is a view taken along a section B1-B2 in FIG. 2a; and

FIGS. 4a to 4i illustrate a process of fabricating an acoustic sensor according to an exemplary embodiment of the present invention.

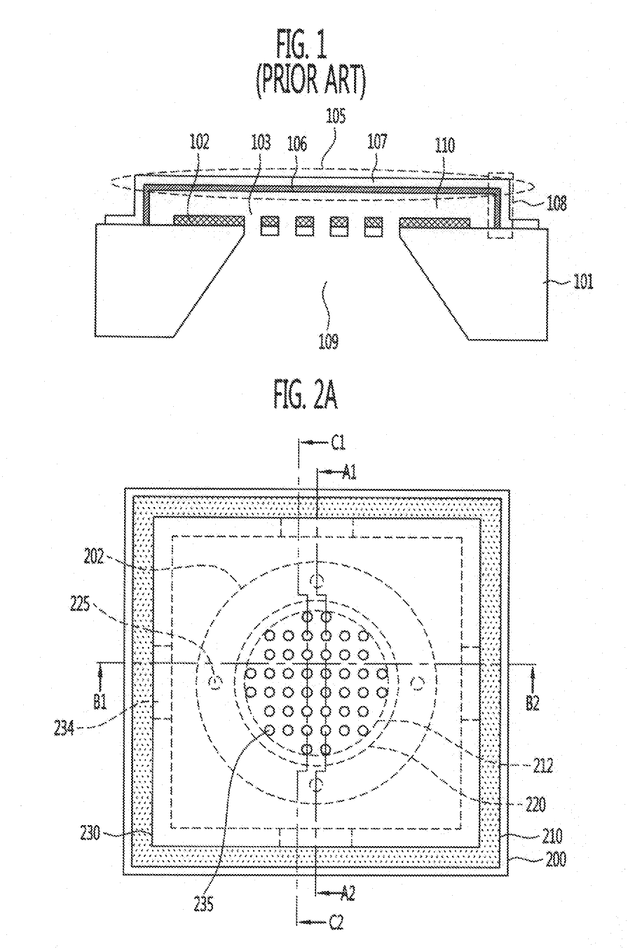

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

As described above, a conventional acoustic sensor has a problem in that a sound-pressure response characteristic of the acoustic sensor is degraded due to a nonlinear component resulting from horizontal movement of a diaphragm and a support.

In order to resolve this problem, the present invention provides a scheme capable of improving a sound-pressure response characteristic by forming a self-sustaining support inward from an edge of a diaphragm to prevent horizontal movement of the diaphragm and the support and suppress creation of a nonlinear component when vibration occurs due to sound pressure.

Also, the conventional method of fabricating an acoustic sensor necessarily requires a process of etching a backside of a substrate to form an acoustic chamber. The process of etching the backside of the substrate complicates an overall fabrication process and reduces a yield.

In order to resolve this problem, the present invention provides a scheme of omitting the process of etching the backside of the substrate by forming a diaphragm to be floated from the substrate and etching an upper portion of the substrate to form an acoustic chamber.

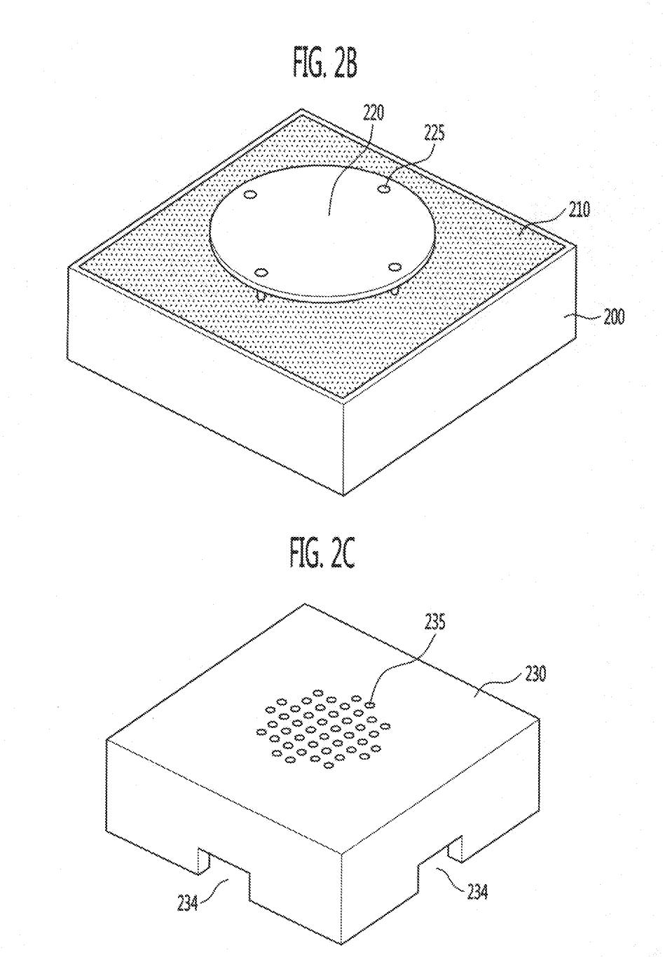

FIGS. 2a to 2c illustrate an acoustic sensor according to an exemplary embodiment of the present invention.

Referring to FIG. 2a, the acoustic sensor according to an exemplary embodiment of the present invention includes a substrate 200, an acoustic chamber 202, an insulating layer 210, an acoustic-chamber open pattern 212, a diaphragm 220, a self-sustaining support 225, a stationary electrode 230, etching windows 234 and etching holes 235.

Components indicated by solid lines in FIG. 2a, i.e., the substrate 200, the insulating layer 210, the stationary electrode 230 and the etching holes 235 can be observed external to the acoustic sensor. Meanwhile, components indicated by dotted lines, i.e., the diaphragm 220, the self-sustaining support 225, the etching window 234, the acoustic-chamber open pattern 212 and the acoustic chamber 202 are formed inside the acoustic sensor.

For easy understanding of the acoustic sensor, the diaphragm 220 and the stationary electrode 230 of the acoustic sensor according to an exemplary embodiment of the present invention in FIG. 2a are shown in FIGS. 2b and 2c, respectively.

Referring to FIG. 2b, the insulating layer 210 is formed on the substrate 200, and the diaphragm 220 supported by the self-sustaining support 225 is formed on the insulating layer 210.

The self-sustaining support 225 is formed inward from an edge of the diaphragm 220. This suppresses horizontal movement of the diaphragm 220 and the self-sustaining support 225 when vibration occurs due to sound pressure. Accordingly, a nonlinear component resulting from the horizontal movement is not created, such that a sound-pressure response characteristic of the acoustic sensor can be improved. Meanwhile, the diaphragm 220 and the self-sustaining support 225 are integrally formed and may have a single-layer structure of a conductive layer or a stacked structure of an insulating layer and a conductive layer. The conductive layer of the diaphragm 220 and the stationary electrode 230 form a pair of upper and lower electrodes.

Meanwhile, Referring to FIG. 2c, the stationary electrode 230 is formed to surround the diaphragm 220 shown in FIG. 2b, and the etching window 234 is formed in a lower portion of each side.

The etching window 234 is formed to flow etching solution or etching gas inward in an etching process for floating the diaphragm 220 and an etching process for forming the acoustic chamber 202 in the substrate 200 in the process of fabricating the acoustic sensor according to an exemplary embodiment of the present invention.

Meanwhile, the etching holes 235 are formed in an upper portion of the stationary electrode 230. The etching holes 235 are formed to flow etching solution or etching gas inward in an etching process for forming a spacing between the stationary electrode 230 and the diaphragm 220 in the process of fabricating an acoustic sensor according to an exemplary embodiment of the present invention.

This process will be described below in connection with the process of fabricating an acoustic sensor according to an exemplary embodiment of the present invention.

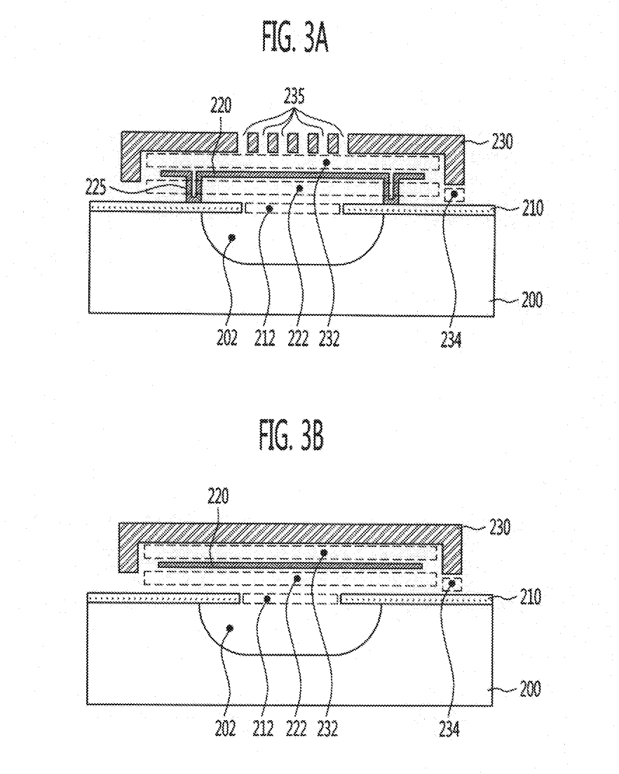

Hereinafter, the acoustic sensor having the above-described configuration according to an exemplary embodiment of the present invention will be described in greater detail with reference to FIGS. 3a and 3b.

FIG. 3a is a view taken along a section A1-A2 in FIG. 2a, and FIG. 3b is a view taken along a section B1-B2 in FIG. 2a.

Referring to FIGS. 3a and 3b, the acoustic chamber 202 is formed in an upper portion of the substrate 200, and the insulating layer 210 is formed on the substrate 200 in which the acoustic chamber 202 is formed.

The acoustic-chamber open pattern 212, which is an area in which the insulating layer 210 is partially etched and removed, is formed in a central area of the insulating layer 210. The acoustic-chamber open pattern 212 is a space formed to etch the substrate 200 while forming the acoustic chamber 202 in the process of fabricating an acoustic sensor according to an exemplary embodiment of the present invention.

Meanwhile, the diaphragm 220 is formed on the insulating layer 210. The diaphragm 220 is supported by the self-sustaining support 225, and a diaphragm gap 222 is formed with the same height as the self-sustaining support 225 between the diaphragm 220 and the insulating layer 210.

Also, the stationary electrode 230 having a structure capable of surrounding the diaphragm 220 is formed on the insulating layer 210. The etching windows 234 are formed in lower portions of the sides of the stationary electrode 230 and are spaced from the insulating layer 210 at a predetermined interval.

The etching windows 234 are formed to flow etching solution or etching gas inward while etching a sacrificial layer to float the diaphragm 220 in the process of fabricating an acoustic sensor according to an exemplary embodiment of the present invention.

Meanwhile, the plurality of etching holes 235 are formed on the stationary electrode 230. The etching holes 235 are formed to flow etching solution or etching gas inward while etching the sacrificial layer to form a spacing (a stationary electrode gap 232) between the stationary electrode 230 and the diaphragm 220 in the process of fabricating an acoustic sensor according to an exemplary embodiment of the present invention.

Meanwhile, the acoustic chamber 202 has a size determined by a total width of the diaphragm 220, which senses a change of capacitance, and a depth determined as a maximum depth that does not cause deformation of the self-sustaining support 225.

The acoustic sensor having the above-described structure according to an exemplary embodiment of the present invention can be fabricated simply without a substrate backside process. Also, since the self-sustaining support 225 is formed inward from the edge of the diaphragm 220, the horizontal movement does not occur when vibration occurs due to sound pressure and a nonlinear component is not created. Accordingly, the sound-pressure response characteristic of the acoustic sensor is improved.

Hereinafter, the process of fabricating an acoustic sensor having the above-described structure according to an exemplary embodiment of the present invention will be described with reference to related drawings.

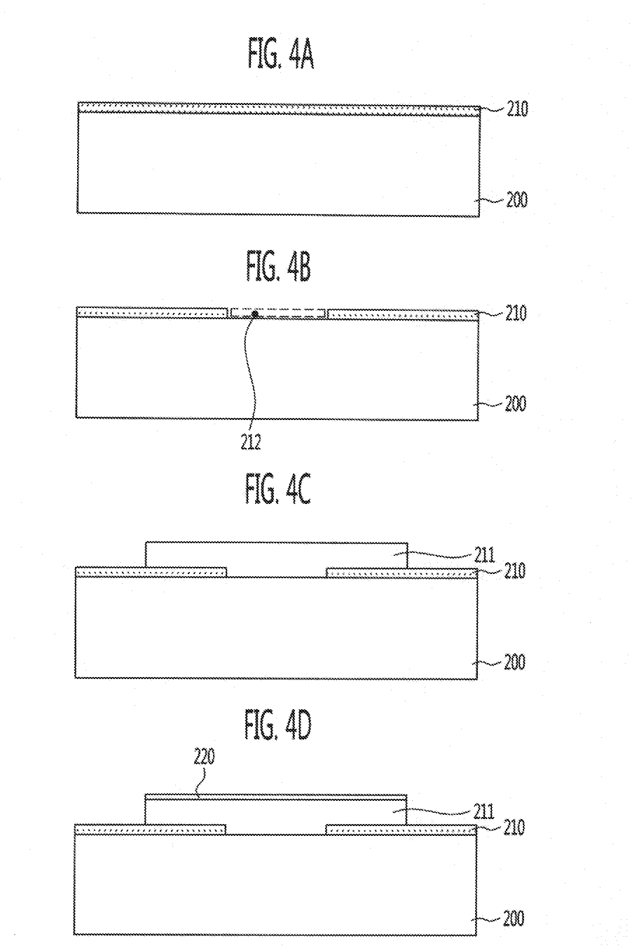

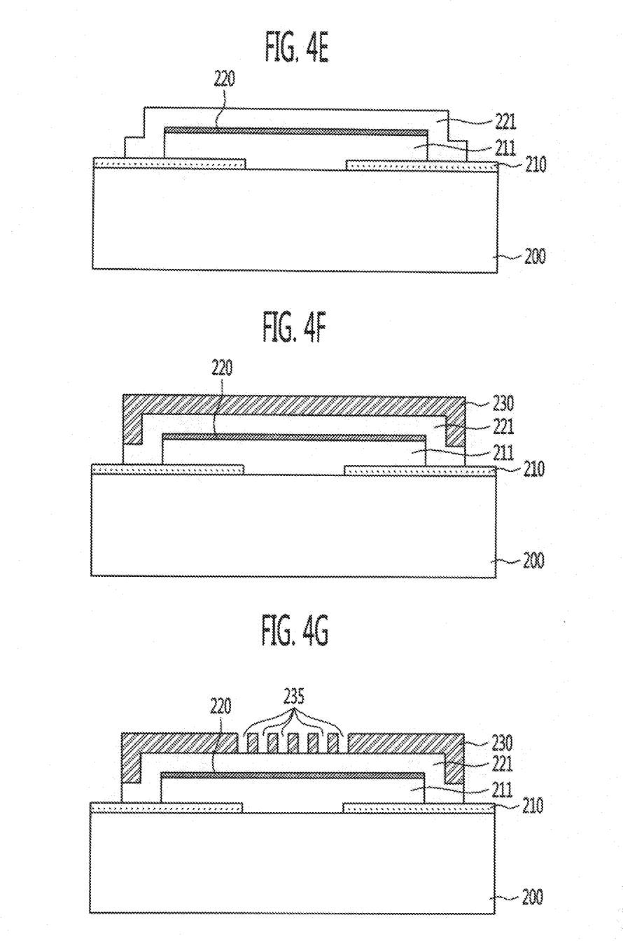

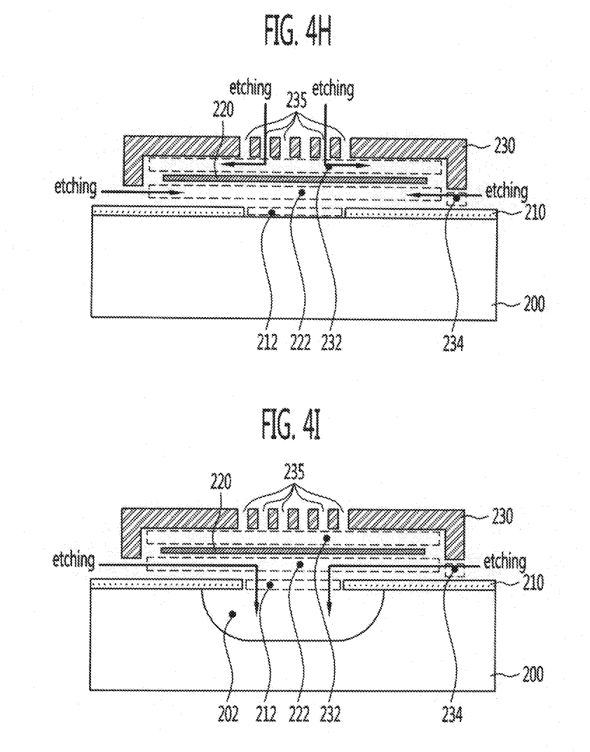

FIGS. 4a to 4i illustrate a process of fabricating an acoustic sensor according to an exemplary embodiment of the present invention. In FIGS. 4a to 4i, respective steps are shown using a section C1-C2 in FIG. 2a so that a process characteristic according to the present invention well appears.

First, as shown in FIG. 4a, the insulating layer 210 is formed on the substrate 200. The substrate 200 may be a solid-state substrate or a flexible organic substrate. The insulating layer 210 may be an oxide layer or an organic insulating layer. The insulating layer 210 may be formed to a thickness of 0.1 to several μm.

As shown in FIG. 4b, a central area of the insulating layer 210 is then etched to form the acoustic-chamber open pattern 212. The acoustic-chamber open pattern 212 is formed to flow etching solution or etching gas inward when the acoustic chamber 202 is formed in the substrate 200 in a subsequent step. Although the acoustic-chamber open pattern 212 may be formed using a photolithography process, the present invention is not limited to the photolithography process.

As shown in FIG. 4c, a first sacrificial layer 211 is then formed to cover the acoustic-chamber open pattern 212 and some portion of the insulating layer 210. The first sacrificial layer 211 is formed to float the diaphragm 220, which will be formed in a subsequent step, from the insulating layer 210. Meanwhile, the first sacrificial layer 211 is formed with a pattern allowing the diaphragm 220 and the self-sustaining support 225 to be integrally formed in a subsequent step. The first sacrificial layer 211 may be formed using an oxide layer or an organic layer through a photolithography process. The first sacrificial layer 211 may be formed to a thickness of several μm.

As shown in FIG. 4d, the diaphragm 220 and the self-sustaining support 225 are then formed on the first sacrificial layer 211. Since FIG. 4 shows the structure on the section C1-C2 in FIG. 2a and thus process characteristics can be seen clearly, the self-sustaining support 225 is not shown. However, it can be seen from FIGS. 2 and 3 and the related descriptions that the self-sustaining support 225 can be formed together with the diaphragm 220 in FIG. 4d.

Meanwhile, the diaphragm 220 and the self-sustaining support 225 are integrally formed in a single-layer structure of a conductive layer or in a stacked structure of an insulating layer and a conductive layer. The diaphragm 220 and the self-sustaining support 225 may be formed to a thickness of several μm through a photolithography process. In this case, the conductive layer may be formed of, for example, a metal, and the insulating layer may be formed using an oxide layer, a nitride layer, a silicon nitride layer or an organic insulating layer. Meanwhile, the self-sustaining support 225 has the same height as the first sacrificial layer 211 formed in the previous step.

As shown in FIG. 4e, a second sacrificial layer 221 is then formed to cover the diaphragm 220 and some portion of the insulating layer 210. The second sacrificial layer 221 is formed to float the stationary electrode 230 formed in a subsequent step from the diaphragm 220. Meanwhile, the second sacrificial layer 221 is formed to have a pattern allowing the etching windows 234 to be formed in a subsequent step. The second sacrificial layer 221 may be formed by depositing an oxide layer or an organic layer and applying a photolithography process. The second sacrificial layer 221 is formed to a thickness of several μm.

As shown in FIG. 4f, the stationary electrode 230 is then formed on the second sacrificial layer 221. The stationary electrode 230 may be formed of a material such as a metal through deposition or electro-deposition. The stationary electrode 230 is formed to a thickness of several p.m.

As shown in FIG. 4g, the etching holes 235 are then formed in the stationary electrode 230. The etching holes 235 are used to etch the second sacrificial layer 221 in a subsequent step. The etching holes 235 may be formed through a photolithography process.

As shown in FIG. 4h, the first sacrificial layer 211 and the second sacrificial layer 221 are then etched and removed. The first sacrificial layer 211 and the second sacrificial layer 221 are etched through the following process.

First, when the first sacrificial layer 211 is etched, exposed lower portions of the sides of the stationary electrode 230 are etched to form the etching windows 234. As etching solution or etching gas flows inward through the etching windows 234, the first sacrificial layer 211 formed between the substrate 200 and the insulating layer 210 and the diaphragm 220 is then etched to form a diaphragm gap 222.

Meanwhile, as etching solution or etching gas flows inward through the etching holes 235 formed in the stationary electrode 230, the second sacrificial layer 221 formed between the diaphragm 220 and the stationary electrode 230 is etched to form a stationary electrode gap 232. The first sacrificial layer 211 and the second sacrificial layer 221 may be etched using dry or wet etching.

As shown in FIG. 4i, the acoustic chamber 202 is then formed in the upper portion of the substrate 200. The acoustic chamber 202 may be formed by flowing etching solution or etching gas inward through the etching windows 234, the diaphragm gap 222 and the acoustic-chamber open pattern 212 formed in the previous steps and etching the substrate 200. Thus, a final structure of the acoustic sensor according to an exemplary embodiment of the present invention is completed.

According to the exemplary embodiment of the present invention, the substrate backside process, which is conventionally necessarily required, can be omitted to simplify a fabrication process. Thus, a yield can be improved.

According to the present invention as described above, a sound-pressure response characteristic of an acoustic sensor can be improved by removing a nonlinear component resulting from horizontal movement of a diaphragm and a support.

Also, a fabrication process can be simplified and a yield can be improved by removing a substrate backside process for forming an acoustic chamber.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An acoustic sensor comprising:
an acoustic chamber formed by etching an upper portion of a substrate;
an insulating layer formed on the substrate and having a central area etched so that the acoustic chamber is exposed;
a diaphragm formed on the insulating layer; and
a stationary electrode formed on the diaphragm.

2. The acoustic sensor of claim 1, further comprising a diaphragm gap formed between the insulating layer and the diaphragm.

3. The acoustic sensor of claim 2, further comprising a self-sustaining support for supporting the diaphragm on the insulating layer.

4. The acoustic sensor of claim 3, wherein the self-sustaining support is formed inward from an edge of the diaphragm.

5. The acoustic sensor of claim 3, wherein the self-sustaining support is formed integrally with the diaphragm.

6. The acoustic sensor of claim 1, further comprising etching holes formed with a pattern on the stationary electrode.

7. The acoustic sensor of claim 1, wherein the stationary electrode is formed to surround the diaphragm on the insulating layer.

8. The acoustic sensor of claim 7, further comprising a stationary electrode gap formed between the diaphragm and the stationary electrode.

9. The acoustic sensor of claim 7, further comprising etching windows formed between an outer circumference of the stationary electrode and the substrate.

10. The acoustic sensor of claim 1, wherein the diaphragm has a structure in which an insulating layer and a conductive layer are stacked.

11. A method of fabricating an acoustic sensor, comprising:
forming an insulating layer on a substrate;
etching a central area of the insulating layer to form an acoustic-chamber open pattern;
forming a diaphragm on the insulating layer;
forming a stationary electrode on the diaphragm; and
etching an upper portion of the substrate, and forming an acoustic chamber exposed by the acoustic-chamber open pattern.

12. The method of claim 11, wherein forming the diaphragm comprises forming the diaphragm to be spaced from the insulating layer.

13. The method of claim 12, wherein forming the diaphragm comprises:
forming a first sacrificial layer to cover the acoustic-chamber open pattern and the insulating layer;
forming the diaphragm on the first sacrificial layer; and
etching and removing the first sacrificial layer.

14. The method of claim 11, further comprising forming a self-sustaining support on the insulating layer to support the diaphragm.

15. The method of claim 14, wherein forming the self-sustaining support comprises forming the diaphragm and the self-sustaining support through the same etching process.

16. The method of claim 11, wherein forming the stationary electrode comprises forming the stationary electrode to be spaced from the diaphragm.

17. The method of claim 16, wherein forming the stationary electrode comprises:
forming a second sacrificial layer on the substrate to cover the diaphragm;
forming the stationary electrode on the second sacrificial layer; and
etching and removing the second sacrificial layer.

18. The method of claim 17, wherein forming the stationary electrode further comprises forming etching holes having a pattern on the stationary electrode.

19. The method of claim 16, wherein forming the stationary electrode comprises forming the stationary electrode to surround the diaphragm on the insulating layer.

20. The method of claim 19, wherein forming the stationary electrode comprises forming etching windows having a pattern between the insulating layer and an outer circumference of the stationary electrode.
